(19) United States
(12) Patent Application Publication
(10) Pub. No.: US 2013/0087580 A1
(43) Pub. Date: Apr. 11, 2013

(54) BEVERAGE TOWER WRAP

(71) Applicants: John Stein, Ogden, UT (US); Joseph C. Stein, III, Ogden, UT (US); Paul Carlsen, North Ogden, UT (US)

(72) Inventors: John Stein, Ogden, UT (US); Joseph C. Stein, III, Ogden, UT (US); Paul Carlsen, North Ogden, UT (US)

(21) Appl. No.: 13/650,019

(22) Filed: Oct. 11, 2012

Related U.S. Application Data
(63) Continuation-in-part of application No. 29/403,811, filed on Oct. 11, 2011.
(60) Provisional application No. 61/545,852, filed on Oct. 11, 2011.

(51) Int. Cl. B67D 7/84; B32B 3/06; B65D 81/38; B23P 11/00

(52) U.S. Cl. 222/183; 29/428; 428/99; 428/100

(57) ABSTRACT

Embodiments of the present invention relate to systems, methods, and apparatus for insulating and/or identifying beverages of a tower beverage dispenser. Particularly, a tower wrap can provide sufficient insulation to a beverage tower of the tower beverage dispenser. For example, the tower wrap can prevent substantial rise in temperature of the beverages located within the beverage tower, while the beverage passes through or remains within the beverage tower.

### CROSS-REFERENCE TO RELATED APPLICATIONS

This application claims priority to U.S. Provisional Patent Application No. 61/545,852, filed Oct. 11, 2011, entitled “Beverage Tower Wrap”, and claims priority to and is a continuation-in-part of U.S. Design Patent Applicant No. 29/403,811, filed Oct. 11, 2011, entitled “Beverage Tower Wrap.” The entire content of each of the above-referenced applications is incorporated herein by reference.

### BACKGROUND OF THE INVENTION

1. The Field of the Invention

This invention relates to systems, methods, and apparatus for insulating and/or marking beverage dispensing towers.

2. Background and Relevant Art

In some instances, beverages can be dispensed from a tower type beverage dispenser. For example, draft beer is commonly dispensed for such dispensers. Tower beverage dispensers typically have a “tower” portion that extends upward above a table or a counter and a valve, which can control flow of the beverage out of the dispenser. Thus, the beverage can flow from a storage location, through the beverage tower of the dispenser, and out of an open valve during a dispensing operation. Furthermore, when the valve is in a closed position, at least some of the beverage can remain in the beverage tower of the dispenser.

While the beverage flows through or remains in the beverage tower of the dispenser, the temperature of the beverage may rise above a preferable temperature for dispensing and/or consumption of such beverage. In some instances, temperature rise may affect dispensing of the beverage. For example, if the temperature of a beer rises above a preferable temperature, excess foam may be generated during dispensing. Thus, some dispensers may incorporate complicated and/or expensive cooling systems or mechanisms, in order to prevent or minimize such rises in temperature of the beverage in the tower. Particularly, cooling mechanisms (e.g., coils) installed inside of the beverage tower can be costly, require additional maintenance, and may prevent dispensing during breakdown periods.

Furthermore, typical tower dispensers can include designer valve handles that can identify available beverages. In other words, such handles can identify a particular valve with a particular beverage that is available for dispensing from such valve. Usually, however, such handles have insufficient area to clearly identify the available beverages. Moreover, such handles can be positioned at various angles (e.g., depending on the valve settings), which can make reading and identifying markings on the handles difficult for the consumers.

Accordingly, there are a number of disadvantages in beverage tower insulation and identification that can be addressed.

### BRIEF SUMMARY OF THE INVENTION

Embodiments of the present invention provide systems, methods, and apparatus for insulating and/or providing identifications for a tower beverage dispenser. In at least one embodiment, the tower wrap can provide sufficient insulation for an otherwise beverage tower, which can eliminate or reduce the need for using expensive and/or complicated cooling equipment to avoid increase in the temperature of the beverage in the beverage tower. For example, the tower wrap can help to maintain beverage located within the beverage tower at a desired temperature, while the beverage passes through the beverage tower. Additionally, in some instance, some amount of beverage can remain in the beverage tower after dispensing; the tower wrap can prevent or mitigate rise in temperature of the beverage remaining in the beverage tower. Thus, the tower wrap can improve dispensing efficiency and may reduce waste.

At least one embodiment includes a tower wrap for a tower beverage dispenser. Such tower wrap includes a flexible wall piece having a first side and a second side. Also, the flexible wall piece is configured to wrap around a beverage tower of the tower beverage dispenser. Additionally, the flexible wall piece is configured to conform to the beverage tower of the tower beverage dispenser. The flexible wall piece of the tower wrap is configured to cover substantially all of the exterior surface area of the beverage tower. Furthermore, the tower wrap has one or more connectors configured to secure the flexible wall piece around the beverage tower of the tower beverage dispenser. The tower wrap can also include one or more visible identifiers located on an outer portion of the flexible wall piece.

One or more embodiments include a substantially un-cooled tower beverage dispensing system for dispensing one or more beverages. Such a system incorporates a beverage tower configured to contain one or more dispensing lines. The beverage tower does not contain any internal cooling mechanisms. For instance, the beverage tower may contain no cooling mechanism or may have only minimal cooling (e.g., the beverage tower may be connected to a cooler or refrigerator and may receive or have cooled air therein. Moreover, the system includes one or more valves extending out of the beverage tower and connected to the one or more dispensing lines. The system also includes a flexible wall piece being wrapped around the beverage tower and conforming to an outer surface of the beverage tower. Additionally, the system includes one or more connectors configured to couple the flexible wall piece to the beverage tower.

Further embodiments also include a method of insulating a beverage tower of a tower beverage dispenser and removably identifying one or more beverages available for dispensing from the tower beverage dispenser. Such method includes selecting a first tower wrap based at least in part on one or more visible beverage identifiers on an outer surface of the first tower wrap. The one or more beverage identifiers correspond with one or more beverages of a first set of beverages available for dispensing from the tower beverage dispenser. Also, the first tower wrap comprises an insulating material. Moreover, the method includes wrapping the first tower wrap about the beverage tower of the tower beverage dispenser. The method further includes removably coupling the first tower wrap to the beverage tower of the tower beverage dispenser.

Additional features and advantages of exemplary embodiments of the invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIG. 1A illustrates a perspective view of an open tower wrap in accordance with one embodiment of the present invention;

FIG. 1B illustrates a perspective view of a closed tower wrap of FIG. 1A;

FIG. 2 illustrates a perspective view of a front view of a closed tower wrap in accordance with another embodiment of the present invention;

FIG. 3 illustrates a perspective view of a perspective view of a closed tower wrap in accordance with yet another embodiment of the present invention;

FIG. 4 illustrates a perspective view of a top portion of a tower wrap in accordance with one embodiment of the present invention;

FIG. 5 illustrates a perspective view of a tower wrap in accordance with still another embodiment of the present invention;

FIG. 6 illustrates a front view of a substantially un-cooled tower beverage dispensing system in accordance with one embodiment of the present invention;

FIG. 7 illustrates a perspective view of a substantially un-cooled tower beverage dispensing system in accordance with another embodiment of the present invention;

FIG. 8 illustrates a back view of a tower wrap installed on a tower beverage dispenser in accordance with one embodiment of the present invention; and

FIG. 9 illustrates another tower wrap installed on a tower beverage dispenser in accordance with yet another embodiment of the present invention.

### DETAILED DESCRIPTION OF THE PREFERRED EMBODIMENTS

Embodiments of the present invention provide systems, methods, and apparatus for insulating and/or providing identifications for a tower beverage dispenser. In at least one embodiment, the tower wrap can provide sufficient insulation for an otherwise beverage tower, which can eliminate the need for using expensive and/or complicated cooling mechanisms inside of the beverage tower to avoid increase in the temperature of the beverage in the beverage tower. For example, the tower wrap can maintain beverage located within the beverage tower at a desired temperature, while the beverage passes through the beverage tower. Additionally, in some instance, some amount of beverage can remain in the beverage tower after dispensing; the tower wrap can prevent or mitigate rise in temperature of the beverage remaining in the beverage tower. Thus, the tower wrap can improve dispensing efficiency and may reduce waste.

Also, the tower beverage dispenser may dispense brewed and/or carbonated beverages, such as beer. In some instances, beer may produce excessive amounts of foam during dispensing, such as when the temperature of the beer has risen above a critical temperature. Thus, in some embodiments, the tower wrap can maintain the temperature of the beer passing through or remaining the in the beverage tower below the critical temperature, which can avoid generating excessive and undesirable foam. Likewise, avoiding excessive foam production can reduce waste and increase dispensing efficiency.

In at least one embodiment, the tower wrap can provide identifying information for consumers as well as operators of the tower beverage dispenser. For example, the tower wrap can include one or more visible identifiers that can identify the particular type and/or brand of beverage being dispensed from the tower beverage dispenser. Moreover, the tower wrap can identify the particular establishment that is dispensing the beverages. The tower wrap also can provide advertising information to the consumers, which may but does not have to be related to the particular beverage being dispensed or to the establishment dispensing the beverage.

Additionally, the tower wrap can be easily interchangeable. Hence, the operator of the tower beverage dispenser can remove and replace the tower wrap. More specifically, the tower wrap can be removed and replaced to identify a different type and/or brand of beverage being dispensed from the particular tower beverage dispenser. Thus, the tower wrap can accurately identify the particular beverage being dispensed. Similarly, the tower wrap containing advertising messages can be exchanged when the operator of the dispenser desires to alter or substitute a different message.

According to one or more embodiments, the tower wrap includes a wall piece formed from an insulating material. The tower wrap can surround the column or tower (i.e., the beverage tower) of the beverage tower dispenser to reduce or eliminate temperature increases in a liquid beverage as the beverage passes through the beverage tower, which in turn can reduce the foaming of the beverage as it is dispensed. Further, the flexible wall piece of the tower wrap is configured to cover substantially all of the exterior surface area of the beverage tower. The tower wrap can include connectors for removably connecting the tower wrap around the beverage tower. This can allow for quick installation and removal of the tower wrap on/from the beverage tower.

In one or more embodiments, the tower wrap has an outer surface configured to be marked upon. As used herein the term “markings” is intended to encompass such things as advertisements, designs, graphics, patterns, logos, pictures, trademarks, trade names, and the like, and combinations thereof Markings may be placed on the outer surface of the wrap using various conventional methods, including but not limited to printing, embroidery, embossing, stenciling, coatings, and the like.

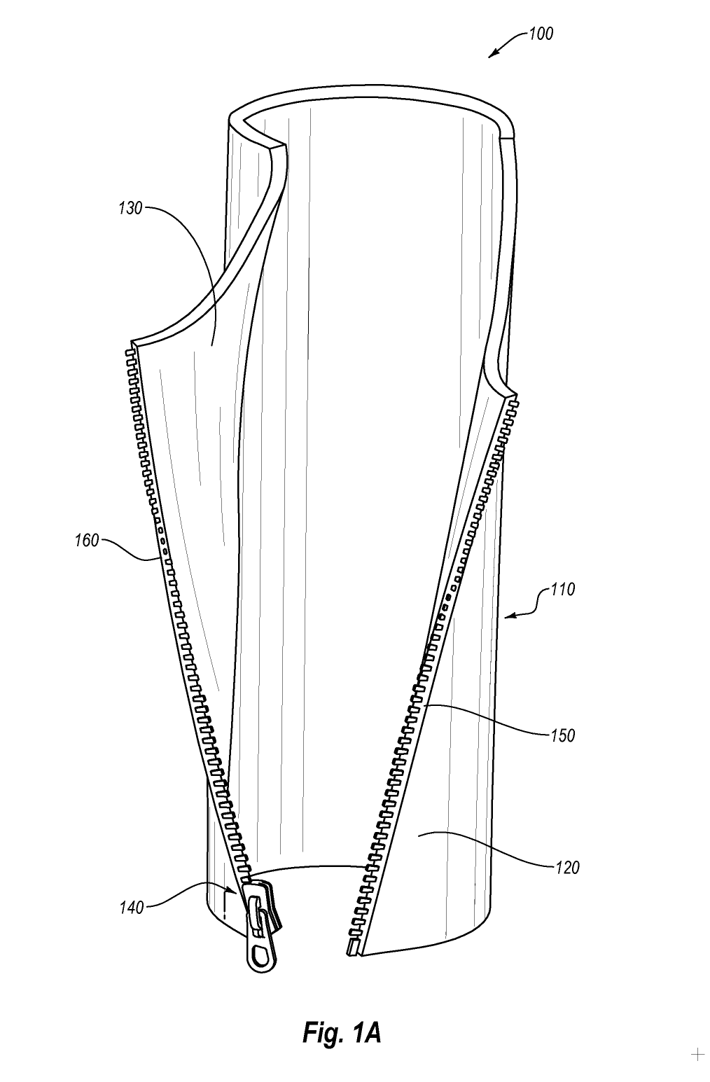

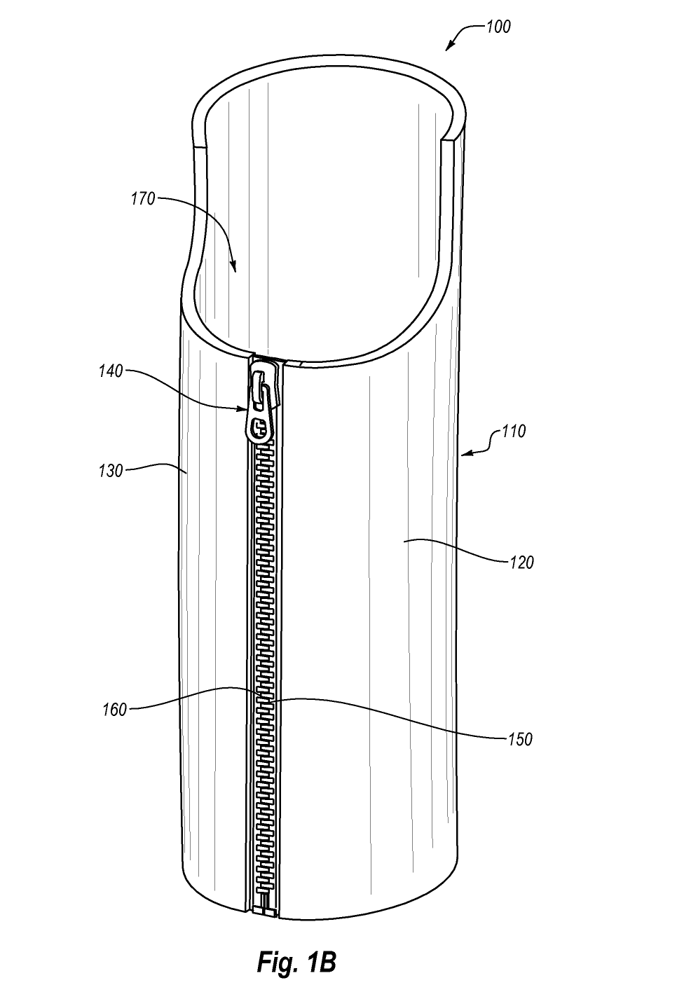

Referring now to the Figures, FIGS. 1A-1B illustrate a tower wrap 100 that can be installed around a beverage tower of a tower beverage dispenser. Particularly, the tower wrap 100 can include a wall piece 110, which may comprise a single or multiple connected pieces of flexible material. Moreover, as described above, the wall piece 110 can be insulating.

For example, as mentioned above, the wall piece 110 can be an insulating material. Suitable materials include but are not limited to neoprene, closed cell foam, open-cell foam, and natural and synthetic rubber materials, including recycled rubber materials, and combinations thereof. Examples of recycled rubber materials include but are not limited to recycled tires.

Moreover, the insulating material of the wall piece 110 may be of varying thicknesses, which can depend on the desired degree of insulation and/or on the shape and size of the beverage tower. In other words, thickness of the wall piece 110 can vary from one embodiment to another, depending on the particular beverage and tower beverage dispenser. For instance, the wall piece 110 can have a thickness of between about ⅛ inch and ¾ inch. However, the wall piece 110 also can have other thicknesses.

Furthermore, the wall piece 110 can have multiple layers. Particularly, two or more layers comprising the wall piece 110 can be coupled together along entire surfaces thereof. Alternatively, the layers may be connected only at some spots. For example, the layers can connect together at one or more edges thereof.

In some embodiments, the tower wrap 100 may include an outer fabric, which can overlay the wall piece 110. Examples of suitable fabrics include but are not limited to polyester, nylon and similar materials. In light of this disclosure, it will be appreciated by one skilled in the art that various types of outer fabrics can be used to allow the tower wrap to carry out the function described herein and increase the visibility of the marking formed on the outer surface such as for identification and/or advertising. Additionally, the markings on the outer surface can be illuminated or formed by one or more lights, such as LED lights, which can be battery-operated or can plug into a standard AC power outlet.

The wall piece 110 can have a first side 120 and a second side 130, which can be separated from each other and can be coupled by one or more connectors. For instance, the tower wrap 100 can include a connector 140, such as a zipper, that can couple together opposing first and second edges 150, 160. In any event, the connector 140 (or multiple connectors) can attach the opposing first and second edges 150, 160 of wall piece 110 around the beverage tower.

It should be noted that particular connectors that couple the opposing first and second edges 150, 160 can vary from one embodiment to another. For example, connectors can include but are not limited to zippers, buttons, hooks, snaps, laces, magnets, and hook and loop fasteners. Furthermore, as further described below, in some embodiments, connectors may couple the opposing first and second sides 120, 130 of the wall piece 110, while the opposing first and second edges 150, 160 are not directly coupled to each other.

In one embodiment, the connector 140 can be fixedly attached to the first and second edges 150, 160 of the wall piece 110. Furthermore, the connector 140 can extend the full length of the tower wrap 100. However, the connector 140 also can have other lengths, sizes or configurations. For instance, the connector 140 can extend only partially along the length of the tower wrap 100.

In some embodiments, the connector 140 can be attached at or near the first and second edges 150, 160 of the wall piece 110. Thus, the connector 140 can be visible on the outside of the tower wrap 100. Alternatively, the connector 140 can be attached such that a portion of the wall piece 110 can cover the connector 140. For example, the wall piece 110 can have flaps that conceal the connector 140 therebetween and thereby increasing the insulating effect of the tower wrap.

When the tower wrap 100 is in a closed configuration (illustrated in FIG. 1B), the tower wrap 100 can have an opening 170 through which the beverage tower and/or the faucets and valves can extend. The opening 170 can have any number of shapes and sizes, which can vary from one embodiment to another. In one example, opening 170 is configured to be large enough to accommodate the faucet and/or valves of the beverage tower, but still covers the majority of the exterior surface area of the beverage tower. More specifically, the shapes and sizes of the opening 170 can allow the tower wrap 100 to be installed around beverage towers of different shapes, sizes, and configurations. Moreover, the tower wrap 100 can have the opening 170 that allows installation of the tower wrap 100 about beverage towers with any number and configuration of faucets.

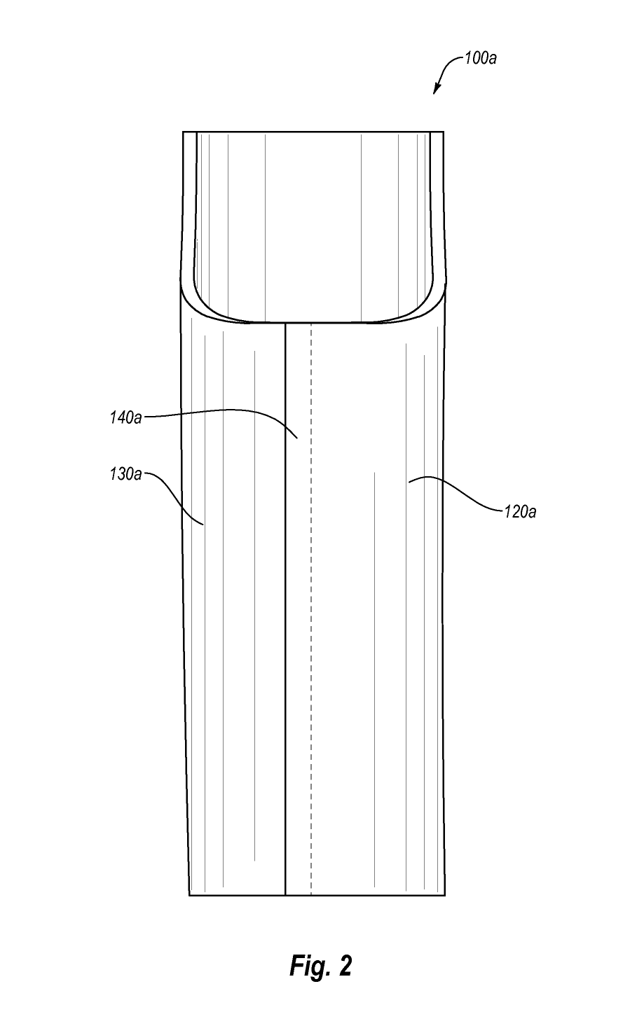

As noted above, the connector (or connectors) 140 can vary from one embodiment to another. For example, as illustrated in FIG. 2, a tower wrap 100a can have a first side 120a coupled to a second side 130a by a connector 140a. The tower wrap 100a can be substantially the same as the tower wrap 100 (FIGS. 1A-1B), except as otherwise described herein. More specifically, the first side 120a and the second side 130a can overlap when coupled together with the connector 140a. Accordingly, the tower wrap 100 can essentially completely wrap the beverage tower about the circumference thereof, which can reduce the temperature rise of the liquid traveling through the beverage tower.

For example, the connector 140a can be a hook and loop type of connector, portions of which can be located on the first and second sides 120a, 130a. Additionally or alternatively, the tower wrap 100a can incorporate the connector 140a that comprises opposing magnetic elements, which can couple the first side 120a and second side 130a about the beverage tower. In some embodiments, such magnetic elements also can couple the first side 120a and/or the second side 130a to the beverage tower. Thus, the connector 140a can couple the first side 120a to the second side 130a and also can couple the first side 120a and/or the second side 130a to the beverage tower. In any event, the connector (or connectors) 140a can allow easy and quick installation and removal of the tower wrap 100a onto/from the beverage tower.

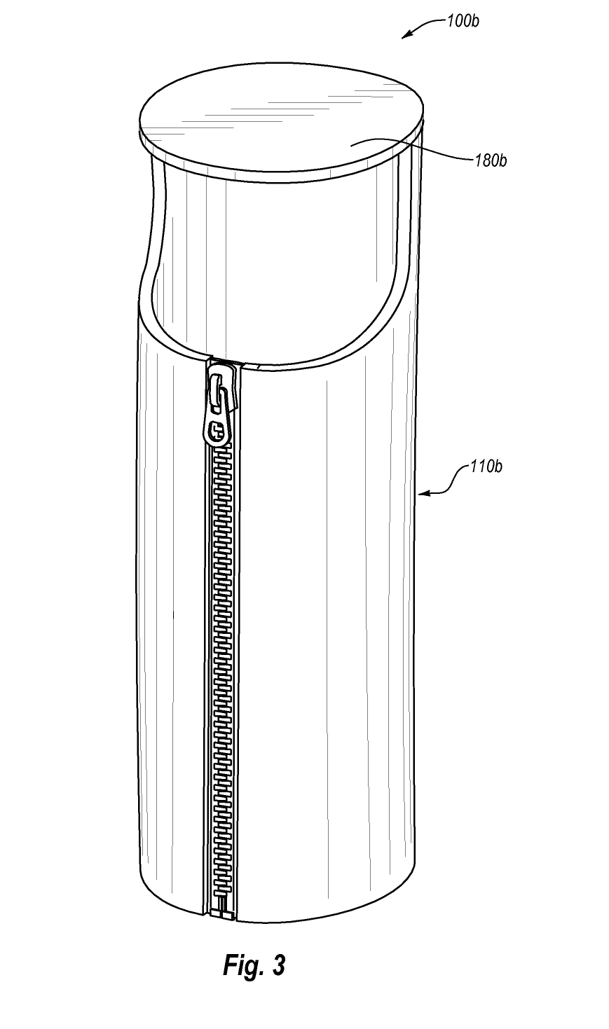

Also, as illustrated in FIG. 3, at least one embodiment includes a tower wrap 100b that has a top portion 180b, which can cover the top of the beverage tower. The tower wrap 100b can be substantially the same as the tower wraps 100, 100a (FIGS. 1A-2), except as otherwise described herein. Also, the top portion 180b can be made of the same or similar material as the wall piece 110 (FIG. 1; described above).

Furthermore, the top portion 180b can couple to a wall piece 110b to form the tower wrap 100b. For example, the top portion 180b can be glued, stitched, welded (e.g., ultrasonically welded), or otherwise permanently secured to the wall piece 110b. Alternatively, the wall piece 110b and/or top portion 180b can have connectors, which can removably couple the top portion 180b to the wall piece 110b. For instance, the top portion 180b can be removably attached to the wall piece 110b with various types of connectors including but not limited to buttons, snaps, hooks, laces, hook and loop fasteners, magnets, and combinations thereof.

The top portion 180b may be attached along an entire length of a top edge of the wall piece 110b. Conversely, the top portion 180b may be attached along one or more points or locations on the wall piece 110b. The top portion 180b also can incorporate magnetic connectors that can allow coupling the top portion 180b to the beverage tower. In any event, the top portion 180b can cover the top of the beverage tower. Moreover, as noted above, the top portion 180b may be removable and/or replaceable. Thus, among other things, the tower wrap 100b can be customized by choosing and incorporating a particular top portion 180b with the particular wall piece 110b.

Also, in one or more embodiments, the top portion 180b can have an exterior surface that can be have markings placed thereon. Hence, the top portion 180b can function to identify beverages and/or dispensing establishment, similar to the wall piece 110b (FIGS. 1A-1B). It will be appreciated that in other embodiments, the exterior surface of the top portion 180b can be configured as an ornamental shape or figure. Additionally, the top portion 180b can be configured to generally conform to the top of the beverage tower. Consequently, the top portion 180b can provide various information to the consumer and/or the operator of the tower beverage dispenser (as mentioned above) and also can help to reduce the rise in temperature of the beverage in the beverage tower.

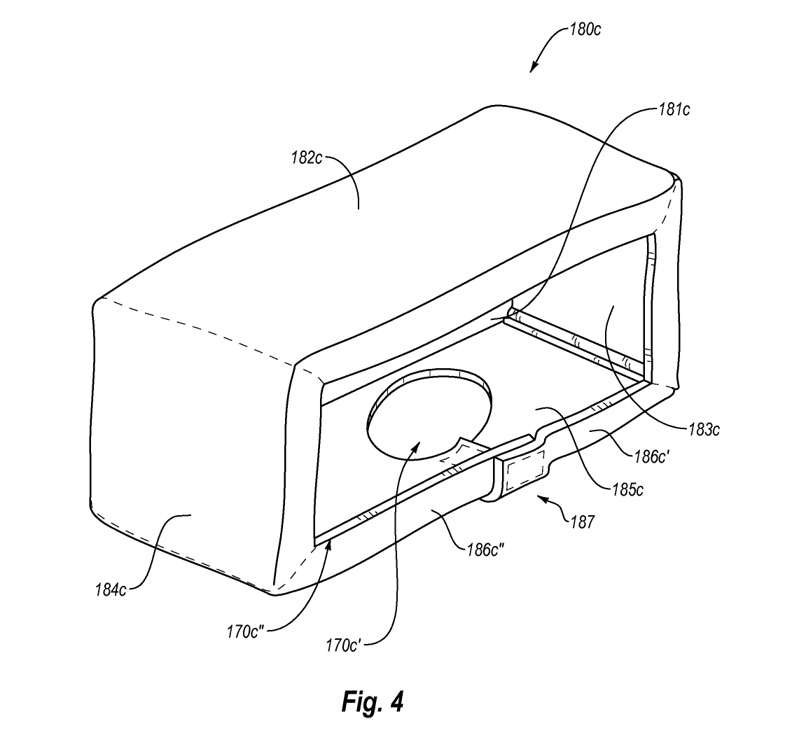

In some embodiments, the top portion 180b can have various configurations, which can accommodate a particular top portion of the beverage tower as well as valves and nozzles thereof. For example, as illustrated in FIG. 4, a top portion 180c can have a substantially rectangular, trapezoidal shape. Particularly, the top portion 180c can have a front panel 181c, a top panel 182c, side panels 183c, 184c, and a bottom panel 185c. The respective front, top, bottom, and side panels 181c, 182c, 183c, 184c, and 185c can allow the top portion 180c to wrap around the top of the beverage tower.

Furthermore, the bottom panel 185c can have an opening 170c′, which can accept and/or wrap around the beverage tower. The top portion 180c also can have a second opening 170c″ that can provide access to the faucet and valves of the tower beverage dispenser. In any event, the top portion 180c can wrap around and insulate the top of the beverage tower. Additionally, the top portion 180c can have at least a partial front panel, which can cover a portion of a front face of the top of the beverage tower.

The front, top, bottom, and side panels 181c, 182c, 183c, 184c, and 185c can couple to each other to form the top portion 180c. For example, the various panels can be glued, stitched, welded, or otherwise connected together to form the top portion 180c. Moreover, the top portion 180c can have a parting line formed between a first side 186c′ and a second side 186c″. Such parting line can allow installation of the top portion 180c around the top of the beverage tower.

Particularly, the first and second sides 186c′, 186c″ can removably couple together with one or more connectors 187. The connectors 187 can be substantially the same as the connectors connector 140 (FIG. 1A), as described above. Accordingly, the first and second sides 186c′, 186c″ can decouple from each other, allowing placement of the top portion 180c around the top of the beverage tower. Subsequently, the first and second sides 186c′, 186c″ can couple together (via connectors 187), to complete installation of the top portion 180c around the top of the beverage tower.

Although the top portion 180c, as described herein, has a substantially rectangular shape, it should be noted that this invention is not so limited. Particular shape of the top portion 180c can vary from one implementation to another, depending on the particular shape of the top of the beverage tower. More specifically, the top portion 180c can surround and/or can stretch about the top of the beverage tower. Thus, the top portion 180c can have any number of panels that can have any suitable shape, which may allow the top portion 180c to wrap around the top of the beverage tower. Furthermore, the top portion 180c can have various identifying and/or advertising markings thereon, similar to the markings described in connection with the wall piece 110 (FIGS. 1A-1B).

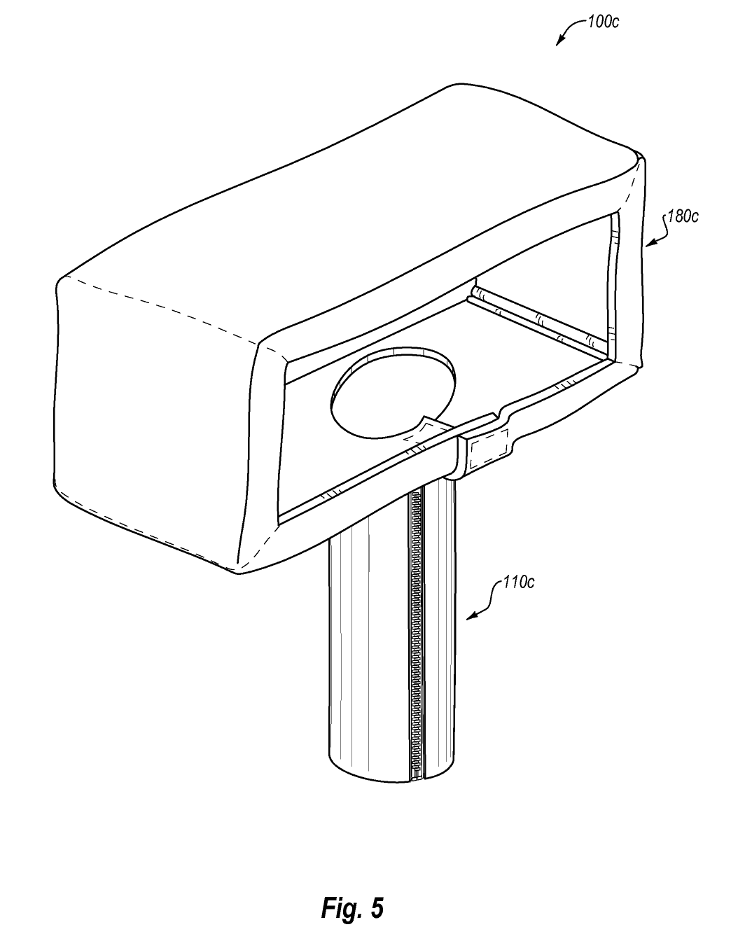

Also, the top portion 180c can be used or incorporated with a wall piece. Particularly, as illustrated in FIG. 5, a tower wrap 100c can have a wall piece 110c and the top portion 180c. The tower wrap 100c can be substantially the same as any one of the tower wraps 100, 100a, 100b (FIGS. 1A-3), except as otherwise described below. Furthermore, a combination of the top portion 180c and the wall piece 110c can have substantially the same relationship and/or connections therebetween as the top portion 180b and the wall piece 110b of the tower wrap 100b (FIGS. 3), except as otherwise described herein.

In some instances, the wall piece 110c and the top portion 180c can be coupled together. For example, a plurality of connectors that can be the same as the connectors 140 (FIGS. 1A-1B), can couple the top portion 180c to the wall piece 110c. Alternatively, the top portion 180c can be permanently coupled to the wall piece 110c (e.g. with stitching, glue, welding, or other suitable connection). Moreover, (similar to the top portion 180b and wall piece 110b (FIG. 3), the top portion 180c can be permanently coupled to the wall piece 110c. Also, in some embodiments, the wall piece 110c may comprise a single piece, which is configured to cover both the beverage tower of a “T” style tower beverage dispenser and the top thereof.

As mentioned above, any one of the tower wraps 100, 100a, 100b, 100c (FIGS. 1A-5) can insulate the tower beverage dispenser and can provide appropriate identification thereof. Moreover, such insulation can be sufficient to avoid costly and/or complicated cooling equipment (e.g., internal cooling mechanisms inside the beverage tower, such as cooled coils or lines) for preventing or minimizing a temperature rise of the beverage passing through or remaining in the beverage tower. Particularly, as the beverage tower is exposed to air, convectional heat transfer can heat the exterior of the beverage tower and, subsequently, can heat the beverage contained in the beverage tower. Any one of the tower wraps described herein can insulate the beverage tower in a manner that minimizes such convectional heat transfer.

For instance, the tower wrap can be placed in tight contact with the beverage tower and/or the top thereof. In some embodiments, the tower wrap and/or the top thereof can stretch about the respective beverage tower and the top of the beverage tower. In one example, the tower wrap and/or the top portion thereof are sized and configured to cover a substantial portion of the exposed surface area of the beverage tower and top thereof, while still accommodating operation of the beverage tower and valves. As such, the tower wrap can minimize or eliminate air flow about the beverage tower and/or the top of the beverage tower (including any air flow between the tower wrap and the beverage tower). Reducing and/or minimizing such air flow can reduce or eliminate convectional heat transfer directly to the beverage tower and/or to the top thereof.

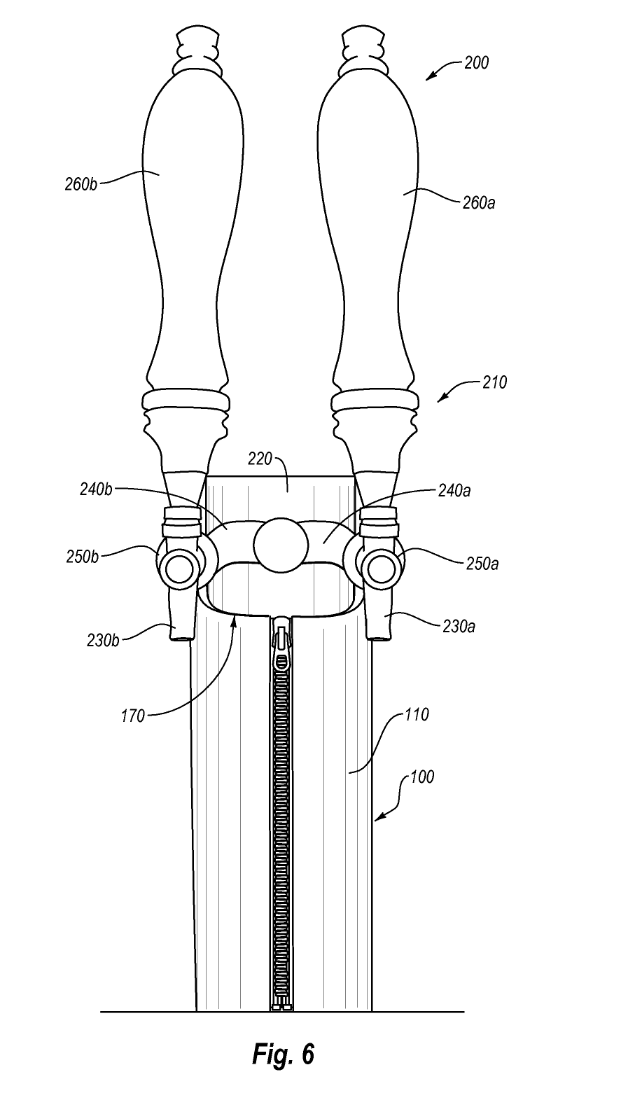

Thus, the tower wrap together with a tower beverage dispenser can form an un-cooled tower dispensing system. For example, FIG. 6 illustrates one embodiment of a substantially un-cooled tower beverage dispensing system 200. Specifically, the substantially un-cooled tower beverage dispensing system 200 can include the tower wrap 100 coupled to a tower beverage dispenser 210. As noted above, the tower wrap 100 can be wrapped around a beverage tower 220, thereby insulating the beverage tower 220.

The beverage tower 220 of the substantially un-cooled tower beverage dispensing system 200 may have no internal cooling mechanisms (e.g., coils or lines). It should be noted, however, that the beverage tower 220 of the substantially un-cooled tower beverage dispensing system 200 can have minimal cooling, such as air cooling. For example, such minimal cooling can be accomplished by connecting the beverage tower 220 to a refrigeration unit and allowing cooled air within the refrigeration unit to enter the beverage tower 220. Additionally, a fan can force such cooled air from the refrigeration unit into the beverage tower 220. Those skilled in the art should appreciate that a refrigeration unit can be any cooling unit located outside of the beverage tower 220 (e.g., a refrigeration unit that cools a beverage container, which supplies the beverage into beverage tower 220).

The substantially un-cooled tower beverage dispensing system 200 also can include one or more faucets, such as faucets 230a, 230b that can be connected to one or more dispensing lines, such as respective dispensing lines 240a, 240b. Furthermore, respective valves 250a, 250b can couple the faucets 230a, 230b to the respective dispensing lines 240a, 240b. Accordingly, an operator of the un-cooled tower dispensing system 200 (or tower beverage dispenser 210) can move respective handles 260a, 260b to open and/or close the respective valves 250a, 250b. When the valves 250a, 250b are in the open position, respective beverages can flow (i.e., can be dispensed) through the valves 250a, 250b and out of the corresponding faucets 230a, 230b. Conversely, when the valves 250a, 250b are in a closed position, beverage may not flow through the respective faucets 230a, 230b.

In the illustrated embodiment, the wall piece 110 of the tower wrap 100 spans substantially the full length of the beverage tower 220 and as such covers substantially all of the external surface area of the beverage tower, while still allowing operation thereof. It should be appreciated that, as mentioned above, the wall piece 110 can have various other lengths, sizes and configurations. For example the wall piece 110 can only partially cover the beverage tower 220.

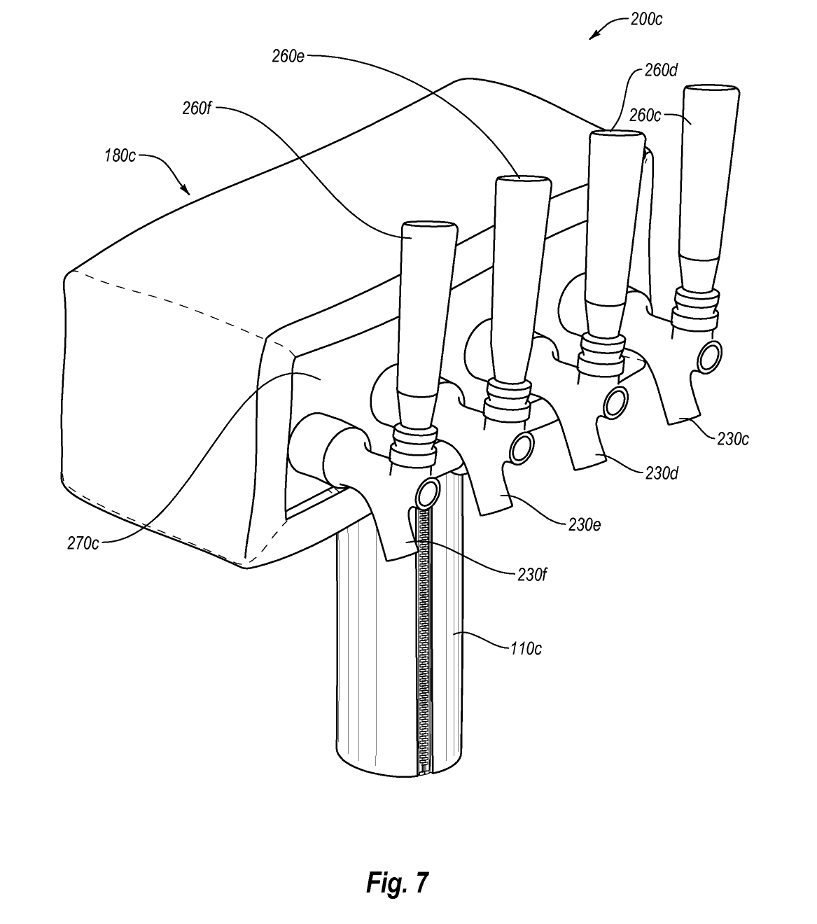

Additionally, as mentioned above, the tower beverage dispenser and the tower wrap can have other configurations. Consequently, the un-cooled tower dispensing system also can have various configurations, shapes, and sizes. For example, as illustrated in FIG. 7, a substantially un-cooled tower beverage dispensing system 200c can have a T-shaped configuration. The substantially un-cooled tower beverage dispensing system 200c can be substantially the same as the substantially un-cooled tower beverage dispensing system 200 (FIG. 6), except as otherwise described herein. Particularly, the substantially un-cooled tower beverage dispensing system 200c can have multiple faucets (e.g., faucets 230c, 230d, 230e, 230f), which can be activated by respective handles 260c, 260d, 260e, 260f.

Additionally, the top portion 180c of the tower wrap can wrap around a top 270c of the tower beverage dispenser. More specifically, the top portion 180c can wrap around the top 270c in a manner to minimize space therebetween and covers a substantial portion of the exposed surface area thereof. For instance, the top portion 180c can stretch around the top 270c, thereby pressing close to the outer surface of the top 270c. As noted above, such stretching can minimize air flow about the top 270c, which can reduce convectional heat transfer to the top 270c and to the beverage located in the top 270c and/or in the beverage tower.

Moreover, the substantially un-cooled tower beverage dispensing system 200c can have the wall piece 110c wrapped around the beverage tower thereof. Similarly, the wall piece 110c can be wrapped in a manner that minimizes air flow between the wall piece 110c and the beverage tower, which can reduce or eliminate convectional heat transfer to the beverage tower. Furthermore, the wall piece 110c can stretch around the beverage tower 220, in a manner that presses the wall piece 110c against the outer surface of the beverage tower 220, thereby minimizing space therebetween.

Additionally, although the above disclosure describes a T-shaped un-cooled tower dispensing system (and a T-shape tower beverage dispenser) other systems and wrap configurations are intended to be within the scope of this disclosure. For instance, tower beverage dispensers can have other styles, such as cylindrical, Metropolis “T”, Metropolis “H”, and Mushroom style towers. Consequently, the substantially un-cooled tower beverage dispensing systems and tower wraps also can have other corresponding styles and configurations. In any event, the tower wrap can have a suitable configuration, such as to wrap around the beverage tower of the tower beverage dispenser (as described herein) and, when wrapped, to from a substantially un-cooled tower beverage dispensing system.

In some instances, beverage towers can have columns ranging from 2.5 inches to 4 inches in diameter. Additionally, some beverage towers are designed with columns that have a variable diameter. Thus, the beverage tower wrap may be sized to fit around any tower having a diameter within a specified range, such as 2.5 inches to 4 inches. For example, the wrap may be manufactured to have a diameter at the low end of the range, but can be sufficiently flexible to expand or stretch to the diameter at the high end of the range. Further, as described herein, the beverage tower wrap can be sufficiently flexible to wrap around towers of varying shapes including the “T” style tower. In any event, as noted above, in some embodiments, the tower wrap can have a snug fit around the beverage tower.

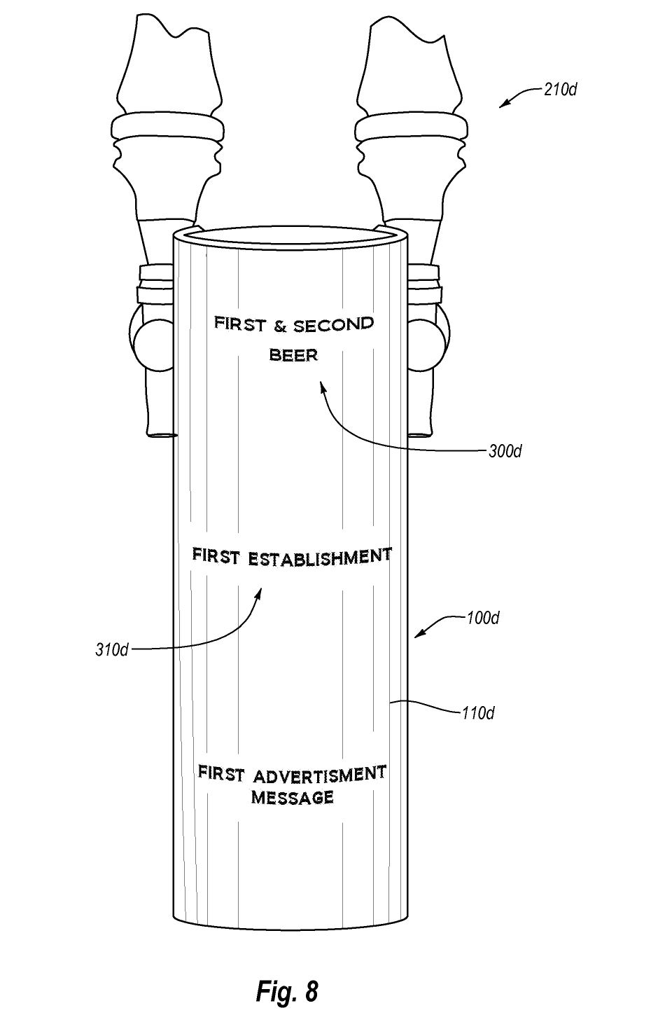

As described above, the tower wrap also can removably or interchangeably identify one or more beverages associated with the particular tower beverage dispenser. Furthermore, the tower wrap can inexpensively and efficiently provide such identification of the tower beverage dispenser. For instance, as illustrated in FIG. 8, a tower beverage dispenser 210d can be wrapped by a tower wrap 100d. The tower wrap 100d can be the same as any one of the tower wraps 100, 100a, 100b, 100c (as described above), except as otherwise described herein.

The wall piece 110d can incorporate various identifying markings, which can be related, for example, to one or more beverages being dispensed from the tower beverage dispenser 210d. More specifically, the wall piece 110d can provide a visible beverage identifier 300d as illustrated in FIG. 8. Moreover, as noted above, the tower wrap 100d can be removable and interchangeable. Consequently, the visible beverage identifier 300d also can be removable and interchangeable, together with the tower wrap 100d.

Accordingly, when one or more beverages change (i.e., the tower beverage dispenser 210d begins to dispense a different beverage than previously), the tower wrap 100d can be changed and replaced to the tower wrap 100d that contains appropriate corresponding visible beverage identifiers 300d. It should be appreciated that, as noted above, removing and replacing the tower wrap 100d can be quickly and easily performed. Thus, the tower wrap 100d can provide up-to-date (or current) identification of the beverages available for dispensing at the particular tower beverage dispenser.

Additionally, the tower wrap 100d can identify a particular establishment that is providing the beverages and/or operating the tower beverage dispenser 210d. More specifically, the tower wrap 100d can include a visible establishment identifier 310d, which can correspond with the particular establishment serving the beverage and/or operating the tower beverage dispenser. For example, in some instances, the tower beverage dispenser can be located outdoors. Moreover, there may be multiple beverage dispensing operations occurring at the same time (e.g., at a fair). Furthermore, the particular tower beverage dispensers may or may not belong to the operators thereof. Thus, owners and/or operators of the tower beverage dispensers can use the wall piece 110d to identify the particular establishment that is associated with a particular power beverage dispenser.

Also, similar to the visible beverage identifier 300d, in one example the establishment identifier 310d can be easily removed and/or replaced from/on the tower beverage dispensers. Accordingly, for example, operators of the tower beverage dispensers can remove the wall piece 110d and, consequently, the establishment identifier 310d from the tower beverage dispensers at the end of operation thereof. Subsequently, the operators can reattach the wall piece 110d and the establishment identifier 310d to the particular tower beverage dispenser the operator will be using, thereby identifying the tower beverage dispenser with the name of the operator's establishment.

Furthermore, in one example placing, removing, and/or exchanging identifying information on the particular tower beverage dispenser can occur without leaving any traces of the previous identification. In other words, the tower wrap 100d and, thus, the visible beverage identifiers 300d and establishment identifier 310d can be completely removed from the beverage tower. Hence, in some instances, the beverage tower may have no tower wrap and no identifying information, and may have no traces of previous tower wrap 100d as well as identifying information that may have been attached to the beverage tower.

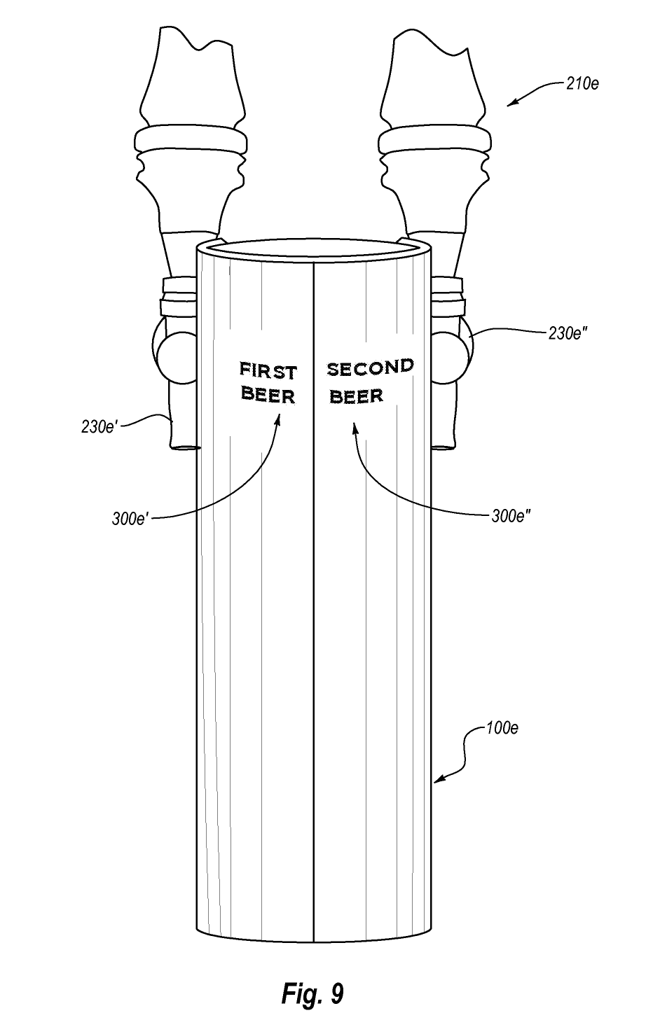

In some instances, the beverage identifiers can approximately correspond with particular faucets dispensing beverages. Thus, in some embodiments, as illustrated in FIG. 9, a substantially un-cooled tower beverage dispensing system 200e can have a first visible beverage identifier 300e′ that corresponds with a first faucet 230e′ of a tower beverage dispenser 210e, and a second visible beverage identifier 300e″ that corresponds with a second faucet 230e″. Accordingly, a consumer can visually identify available beverages at a particular tower beverage dispenser 210e. Moreover, by comparing the location of the container with the particular visible beverage identifier on the tower wrap 100e, the consumer can oversee that the beverage being poured into the consumer's container is the beverage desired and/or purchased by the consumer.

Additionally, embodiments of the present invention include tower wraps that are designed to expand in specified locations. More specifically, expansion of such specified areas of the wrap that will only experience minimal expansion, for instance, when used on larger diameter beverage towers. Thus, the tower wraps can preserve the appearance of the various identifier provided thereon.

In one or more embodiments, the areas of the wrap that will only experience minimal expansion that can be controlled by attaching a second material, which is less flexible than the insulating material, such as plastic, on the interior of the wrap over the area of the wrap where less expansion is desired. For example, a square piece of second material may be attached in an area where a marking is to appear on the wrap to prevent the marking from skewing when the wrap is installed around a tower having a larger dimension than the un-stretched wrap. In another possible embodiment, the areas of the wrap that will experience minimal expansion can be made of one material while the areas that expand more are made of a more flexible material or

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A tower wrap for a tower beverage dispenser, the tower wrap comprising:
a flexible wall piece being configured to wrap around a beverage tower of the tower beverage dispenser, the flexible wall piece being configured to conform to the beverage tower of the tower beverage dispenser;
one or more connectors configured to secure the flexible wall piece around the beverage tower of the tower beverage dispenser; and
one or more visible identifiers located on an outer portion of the flexible wall piece.

2. The tower wrap as recited in claim 1, wherein the flexible wall piece is stretchable and configured to stretch around the beverage tower.

3. The tower wrap as recited in claim 1, wherein the flexible wall piece comprises an insulating material.

4. The tower wrap as recited in claim 1, wherein the one or more visible identifiers are configured to identify the at least one beverage available for dispensing form the tower beverage dispenser.

5. The tower wrap as recited in claim 1, further comprising a top portion secured to the wall piece.

6. The tower wrap as recited in claim 5, wherein the top portion comprises a plurality of interconnected panels, the top portion being configured to wrap around a top of the beverage tower.

7. The tower wrap as recited in claim 1, wherein the one or more connectors are configured to couple the flexible wall piece directly to the beverage tower.

8. The tower wrap as recited in claim 1, wherein the one or more connectors are selected from the group consisting of: a zipper, one or more buttons, one or more snaps, one or more hooks, one or more laces, hook and loop fasteners, magnets, and combinations thereof.

9. A tower wrap for a tower beverage dispenser having at least one valve, the tower wrap comprising:
a flexible wall piece having an opening formed therein, the opening being configured to cooperate with the at least one valve of the tower beverage dispenser, the flexible wall piece being configured to wrap around a beverage tower of the tower beverage dispenser, the flexible wall piece being configured to conform to the beverage tower of the tower beverage dispenser; and
a connector to selectively secure the flexible wall piece around the beverage tower of the tower beverage dispenser,
wherein the flexible wall piece is sized and configured such that the exterior surface of the tower beverage dispenser is substantially covered.

10. A substantially un-cooled tower beverage dispensing system for dispensing one or more beverages, the system comprising:
a beverage tower configured to contain one or more dispensing lines, the beverage tower not containing any internal cooling mechanisms;
one or more valves extending out of the beverage tower and connected to the one or more dispensing lines;
a flexible wall piece being wrapped around the beverage tower and conforming to an outer surface of the beverage tower; and
one or more connectors configured to selectively couple the flexible wall piece to the beverage tower.

11. The system as recited in claim 10, wherein:
the flexible wall piece has a first side and a second side; and
the one or more connectors couple the first side to the second side.

12. The system as recited in claim 10, wherein:
the flexible wall piece has a first edge and a second edge; and
the one or more connectors couple the first edge to the second edge.

13. The system as recited in claim 10, wherein the flexible wall piece is stretched about the beverage tower in a manner that presses the flexible wall piece against an outer surface of the beverage tower.

14. The system as recited in claim 10, wherein the flexible wall piece further comprises one or more visible beverage identifiers corresponding with one or more beverages available for dispensing from the substantially un-cooled tower beverage dispensing system.

15. The system as recited in claim 10, wherein the one or more visible beverage identifiers comprise text indicating at least one beverage of the one or more beverages available for dispensing from the substantially un-cooled tower dispensing system.

16. The system as recited in claim 10, wherein the flexible wall piece further comprises one or more visible identifiers corresponding with an establishment operating the substantially un-cooled tower beverage dispensing system.

17. A method of insulating a beverage tower of a tower beverage dispenser and removably identifying one or more beverages available for dispensing from the tower beverage dispenser, the method comprising:
selecting a first tower wrap based at least in part on one or more visible beverage identifiers on an outer surface of the first tower wrap, the one or more beverage identifiers corresponding with one or more beverages of a first set of beverages available for dispensing from the tower beverage dispenser, the first tower wrap comprising an insulating material;
wrapping the first tower wrap about the beverage tower of the tower beverage dispenser; and
removably coupling the first tower wrap to the beverage tower of the tower beverage dispenser.

18. The method as recited in claim 17, wherein wrapping the first tower wrap about the beverage tower of the tower beverage dispenser comprises stretching the first tower wrap and allowing the first tower wrap to press against an outer surface of the beverage tower of the tower beverage dispenser.

19. The method as recited in claim 17, wherein removably coupling the first tower wrap to the beverage tower of the tower beverage dispenser comprises coupling a first side of the first tower wrap to a second side of the first tower wrap.

20. The method as recited in claim 17, wherein removably coupling the first tower wrap to the beverage tower of the tower beverage dispenser comprises coupling a first edge of the first tower wrap to a second edge of the tower wrap.

21. The method as recited in claim 17, further comprising:
forming a second set of beverages available for dispensing from the tower beverage dispenser by replacing at least one beverage of the one or more beverages of the first set of beverages;
removing the first tower wrap from the beverage tower of the tower beverage dispenser; and
coupling a second tower wrap to the beverage tower of the tower beverage dispenser, the second tower wrap containing visible identifiers corresponding with one or more beverages of the second set of beverages available for dispensing from the tower beverage dispenser.
